(19) United States
(12) Patent Application Publication
(10) Pub. No.: US 2013/0290361 A1
(43) Pub. Date: Oct. 31, 2013

(54) MULTI-GEOGRAPHY CLOUD STORAGE

(71) Applicants: Eric A. Anderson, Mountain View, CA (US); John Johnson Wylie, Cupertino, CA (US); Joseph A. Tucek, Palo Alto, CA (US)

(72) Inventors: Eric A. Anderson, Mountain View, CA (US); John Johnson Wylie, Cupertino, CA (US); Joseph A. Tucek, Palo Alto, CA (US)

(21) Appl. No.: 13/460,806

(22) Filed: Apr. 30, 2012

(51) Int. Cl. G06F 17/30; G06F 15/16

(52) U.S. Cl. 707/758; 707/E17.005

(57) ABSTRACT

A multi-geography cloud storage system includes a first data center, with a first key-lookup server to access a first lookup table; and a first fragment server to store data or meta data associated with keys; and a second data center, with a second key-lookup server to access a second lookup table; and a second fragment server to store data associated with the keys; and a storage device to store a redundancy specification.

### BACKGROUND

Data centers with cloud storage provide storage capacity over a network. In a cloud storage model, various hosting servers may virtually pool resources together, thereby sharing storage space. In a cloud storage implementation, data center operators may receive a request for data, and retrieve the data based on a request made by the user accessing the data.

Cloud storage systems may be implemented with various applications, such as web-based interfaces, smart phone applications, or the like. By allowing a user to store data via cloud storage, several key advantages are realized. For example, a user or company may only pay for storage capabilities they need.

Also, cloud storage allows for redundancy of distributed data. Thus, data could be stored in more than one location. By providing the redundancy along with the distributed data, data protection and integrity is ensured. If a user tries to access data in a server, and the server is non-operational, redundancy enables the user to be redirected (for example, by an operator of a data center) to another location.

A cloud storage system may store data as objects in a bucket. The objects may correspond to files associated with the user or owner of the bucket. Additionally, each object may have a unique identified key. The names of the buckets and keys may be chosen so as to be addressable by a URL.

In adding redundancy to a cloud storage system, objects and buckets are stored at various data centers. Thus, an object or bucket in a first data center may be copied to, or stored at various data centers via an erasure code, to a second data center. By adding this redundancy, if a user attempts to access the first data center, and finds that this access is not permissible or possible, the second data center could then be accessed.

### DESCRIPTION OF THE DRAWINGS

The detailed description refers to the following drawings in which like numerals refer to like items, and in which:

FIG. 1 illustrates a block diagram of an embodiment of a cloud storage system;

FIG. 2 is an illustration of a conceptual view of a key-value service according to an embodiment;

FIG. 3 illustrates a vector of a modified redundancy specification according to an embodiment;

FIG. 4 illustrates an example of a user interface to allow a user to select the storage of an object; and

FIG. 5 illustrates a lookup table according to an embodiment.

### DETAILED DESCRIPTION

A cloud storage system allows data storage over multiple servers in a data center. In a standard distribution over a cloud storage system, data may reside as objects stored in a bucket. Each bucket may reside in a single data center or metropolitan area. This implementation may be referred to as a single geography implementation.

Disclosed herein is a system and method for implementing cloud storage in a multi-geographical implementation. By providing a multi-geographical implementation, various buckets can be efficiently and securely stored in multiple locations. Thus, data may not be restricted to a server at a single location, such as Austin. According to the aspects disclosed herein, data may be stored in several different locations, such as Austin and London.

One method for providing multi-geographical storage is to replicate objects, keys or buckets at all available data centers or sources of storage of a cloud storage system. Once the data is stored in all servers of all data centers, then no matter which server in which data center a user accesses, the data will be available. However, this replicating storage scheme wastes resources and may far exceed the user's redundancy requirements. Further, there may be reasons for a user to explicitly want to avoid using some data centers. For instance, it may be illegal according to the laws governing personally identifiable information for a French company to store their data in a datacenter outside of the European Union. Similarly, a US military contractor may want to avoid storing data in data centers outside of NATO countries.

Thus, disclosed herein are aspects that cover a discriminating method of distributing data among data centers. By providing a multi-geographical user is provided extra redundancy. However, the system and method allow the user to determine which of the multiple geographies to use, based, for example on need and resources. Allowing the user to make this determination adds flexibility to a key-value based cloud service storage system.

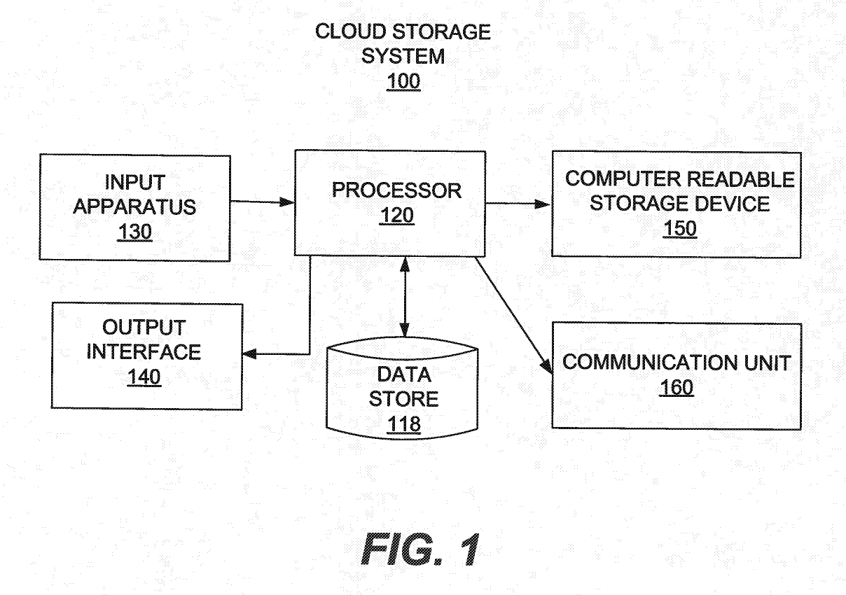

FIG. 1 illustrates a block diagram of an embodiment of a cloud storage system 100. In FIG. 1, the cloud storage system 100 includes a processor 120, an input apparatus 130, an output interface 140, and a data store 118. The processor 120 implements and/or executes the cloud storage system 100. The cloud storage system 100 may include a computing device, an integrated and/or add-on hardware component of the computing device. Further, the system 100 includes a computer readable storage medium 150 that stores instructions and functions for the processor 120 to execute.

The processor 120 receives an input from input apparatus 130. The input apparatus 130 may include, for example, a user interface through which a user may access data such as, objects, software, and applications that are stored in the data store 118. In addition, or alternatively, the user may interface with the input apparatus 130 to supply data into and/or update previously stored data in the data store 118.

In a cloud storage implementation, several duplicates of the cloud storage system 100 may be provided. Thus, a communication unit 160 also provided. The communication unit 160 allows data that is stored in the various duplicates of the cloud storage system 100 to be shared with other data centers. The communication unit 160 may communicate via different protocols depending on a user's capabilities and/or preferences. The various elements included in the cloud storage system 100 of FIG. 1 may be added or removed based on a data center implementation. For example, if a cloud storage system 100 is implemented in a data center devoted to storage, an input apparatus 130 may not be used.

The elements associated with the cloud storage system 100 may be duplicated to implement a multiple number of servers and nodes based on an implementation of a cloud storage as prescribed by a user or system.

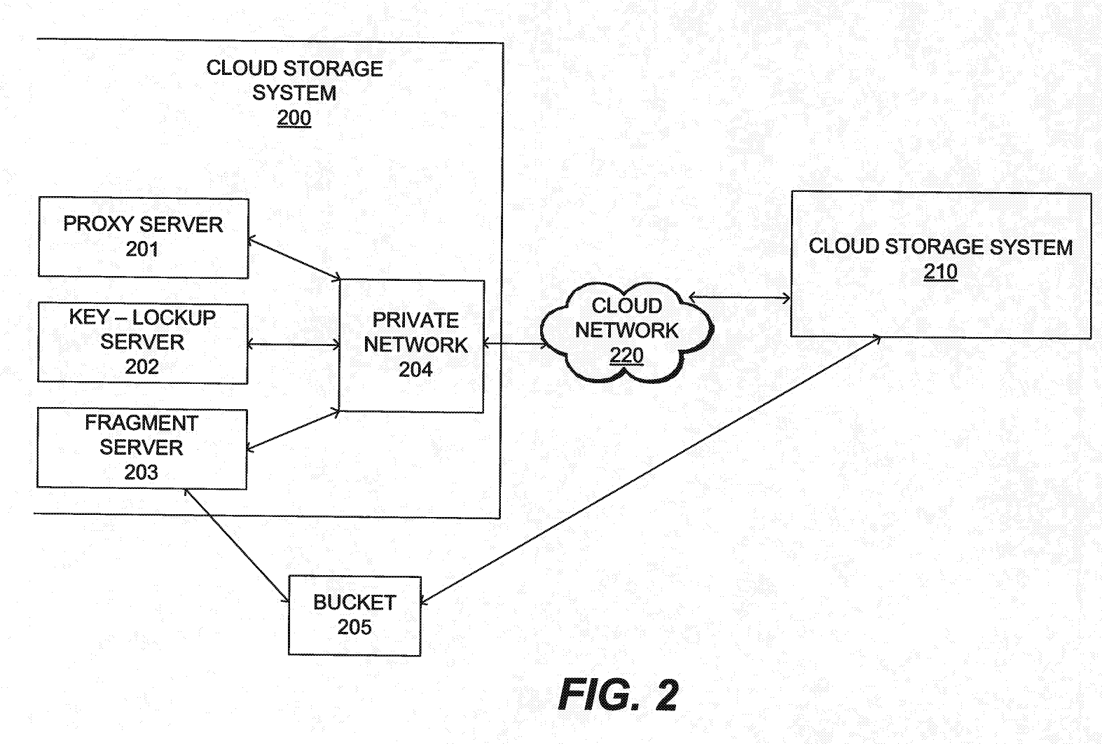

FIG. 2 is a conceptual view of a key-value service according to an embodiment. In FIG. 2, a key-value service 200 includes nodes of the type: proxy nodes 201 (or front end node, head node), key-lookup server nodes 202 (or meta data server, directory server, name nodes), and fragment server nodes 203 (or data server, object server). The nodes of the key-value service 200 may interact to with each other via a private network 204. The proxy nodes 201, key-lookup server nodes 202, and the fragment server nodes 203 may be implemented on a single physical machine, or on separate machines.

The proxy nodes 201 receive http requests, or access attempts from a user or system to retrieve, store, or manipulate data. The proxy nodes 201 use backend protocols to generate key-values to perform the data operations, and access the objects.

The key-lookup server nodes 202 store metadata about various objects. Thus, once a key-value is determined, the key-lookup server nodes 202 may assist in the determination of the location of where various fragments of data may be located. Each of the key-lookup server nodes 202 may contain a lookup table that includes meta data that may be used to determine a location of each fragment or object.

The fragment server nodes 203 allow the objects to be broken into and stored as fragments. By doing this, various objects and fragments of objects may be distributed across fragment server nodes 203 and/or the data centers, thereby providing a more efficient method of storage.

In an embodiment, the various objects (i.e., data stored in the cloud storage system) may be stored using a redundancy specification and a key value. For each object stored in a data center, the lookup table has a key identifying the object, the redundancy specification, and the location of fragments. The redundancy specification may be made on a bucket 205 basis.

A redundancy specification may include an erasure code that allows a user to specify an arbitrary number of data and parity fragments, and generates a representation associated with the value of the data and the parity. Thus, the erasure code is determined by a redundancy specification to transform an object into a number of data and parity fragments. The erasure code may be systematic (stores all the data fragments) or non-systematic (stores only parity fragments). The erasure code may be MDS (maximum distance separable) or non-MDS in nature.

A key value service 200 uses erasure codes to enable a redundancy specification to specify a redundancy level. If a PUT protocol is accessed, each object may be split into smaller fragments (i.e. portions of an object) which are spread and stored along the various fragment server nodes 203.

The storage of data via an erasure code is merely an example, and thus, data according to aspects disclosed herein, may be stored or duplicated by other techniques. To retrieve a particular object, #data fragments are retrieved from the total #data+#parity fragments.

In parallel with the cloud storage system 200, a cloud storage system 210 also may be provided. The cloud storage system 210 may communicate and share information with the cloud storage system 200. While two cloud storage systems are shown in FIG. 2, communicating via a cloud network 220, the number of cloud storage systems according to aspects disclosed herein is not limited to two systems.

By providing multiple cloud storage systems, various data replication regimes may be implemented, such as solid state drives (SSD) and redundant array of independent disks (RAID). This is partially implemented by at least replicating the key-lookup server nodes 202 in each cloud storage system. Thus, if cloud storage system 200 receives an access, the key-lookup server node 202 may determine either that the object being looked up is associated with the system 200, or is located remotely or in another cloud storage system, such as the system 210.

In the cloud storage systems 200 and 210, data may be stored in two levels. First, each individual file is represented as an object, which is logically contained in one of many buckets, such as a bucket 205. The bucket 205 is provided in every data center, and the bucket 205 is used to store objects (such as files) associated with a user who is an owner of bucket 205. The bucket 205 may be associated with authentication information, i.e. a password to be entered so a user may access the bucket. A user may provide the authentication information to access the contents of the bucket 205. Once a user enters the correct authentication information, the bucket 205 may be accessed by the user entering the correct authentication.

After the bucket 205 containing the object is allowed to be accessed by a user, a further authentication associated with the object itself also may be required to allow the user to access the object.

A redundancy specification may be implemented with the cloud storage systems 200 and 210. The redundancy specification, may contain three values specified by a user, for example, #data, #parity in a first data center, and #parity in the second data center.

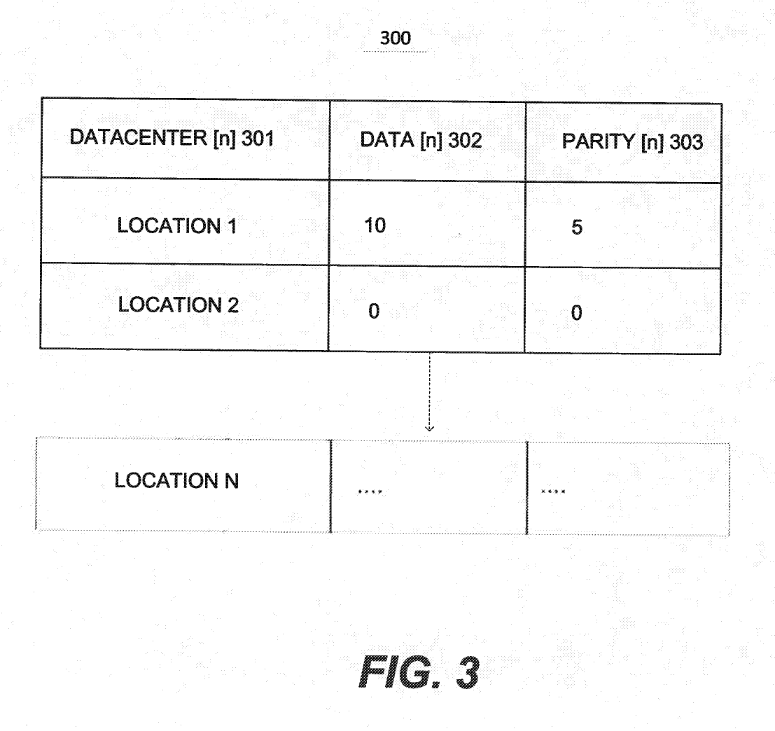

To provide a multi-geographical storage capability, the system 200 implements an extended redundancy specification, an embodiment of which is shown in FIG. 3. The redundancy specification is extended because it is modified to incorporate a multi-geographical storage according to aspects disclosed herein. Extended redundancy specification 300 includes vectors associated with each stored object (rather than just the three values, for example, #data, #parity in first data center, and #parity in the second data center). As FIG. 3 shows, the extended redundancy specification includes datacenter[id] 301, data[id] 302, and parity[id] 303. The ‘id’ term is a variable, and is used to represent that the specific vector represents a datacenter associated with ‘id’. Thus, if an object is stored in data center 1, the redundancy specification for the object may contain the following vectors:

datacenter[2] data[2], parity[2]. . . .

The vectors for the object stored in data center 1 according to the example shown above indicate an id associated with the data center in which the object, or a fragment of the object, is stored at data center 2 (datacenter[2]), the amount of data being duplicated (data[2]), and the parity associated with the duplication(parity[2]).

The extended redundancy specification may allow a user to select on a per data center basis, how much parity and data is stored. The resulting required storage volume may be calculated based on the following relationship:

object-size*(\sum(data[n])+\sum(parity[n]))/\sum(data[n])

In addition to providing a vector for each object denoting a data center, data and parity, the redundancy specification may include a vector that points to the key-lookup servers. This one-dimensional vector may be represented as: vector(datacenter[id]). Based on the modifications to a redundancy specification, as shown by extended redundancy specification 300, various data centers may be assigned to house key-lookup servers, while another set of data centers (not mutually exclusive) may be assigned to house the object.

To implement the vectors, the datacenter[id] may be represented by a Boolean variable. A Boolean variable is a true or false representation of data. In a Boolean variable implementation, each datacenter[id] may have a ‘true’ value indicating that that datacenter[id] is available for use as a redundancy location. Or conversely, if the datacenter[id] has a ‘false’ value, a ‘false’ value indicates that datacenter[id] is not available for use as a redundancy location. Doing so may conserve storage space. Other vector modifications could also be implemented such as a run length encoding of the vector and a small multi-bit representation (e.g. a Huffman or arithmetic code) of each data-center ID.

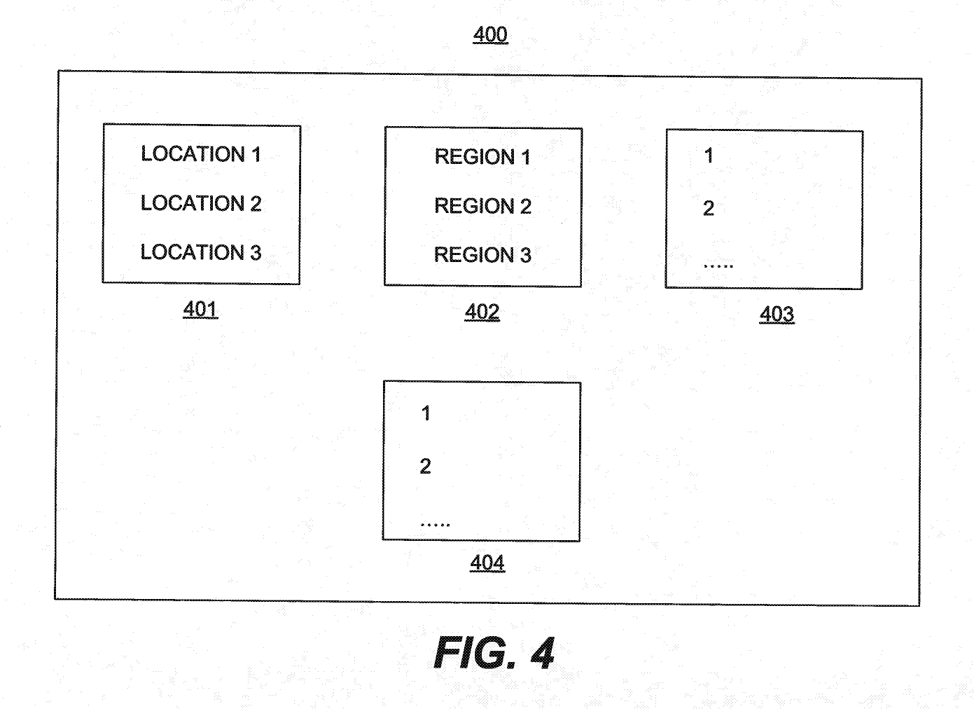

FIG. 4 illustrates an example of a user interface that allows a user to define the storage of an object. In FIG. 4, a sample user interface to create an object is displayed at window 400. In window 400, a user may be presented with several options to limit or choose the geography of the associated storage of the object. For example, in window 401, a user can enumerate specific locations to store the object. Alternatively, a user may select geographies of locations to prohibit the storing of the object. Thus, by selecting a specific location or several specific locations, an extended redundancy specification may be created by incorporate the selected options selected by the user, thereby ensuring that the object will be stored according to the selections by the user in window 400.

In window 402, a user may select specific geographical locations. For example, if the user selects Midwest, the data centers located in the Midwest are added to the extended redundancy specification as eligible for storing data associated with the bucket being created.

In window 403, a user may select the number of data centers. When a user selects the number, the cloud storage system 100 may randomly determine which of the data centers to use. Alternately, the system 100 may use a selection algorithm to determine which of the data centers to use.

Along with selecting the location(s), the number of fragments 404 stored per location also may be chosen. Thus, for each data center, the extended redundancy specification may set the limitations of storage in that data center based on the number of fragments selected at 404.

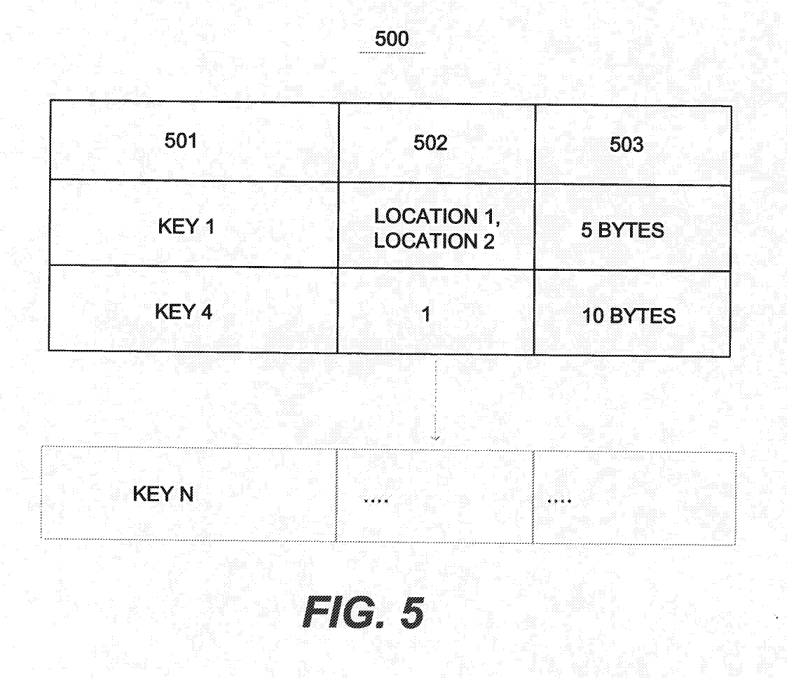

FIG. 5 illustrates an example of a lookup table. The lookup table 500 includes a key field 501, a location field 502, and a size of the object field 503. The actual fields of the lookup table 500 may be expanded based on the implementation desired by a user or a requirement of a system.

Each data center contains a lookup table 500. The lookup table 500 is modified according to objects stored in a data center in which the lookup table 500 is stored. Thus, if the data center is located in Austin, the lookup table 500 for this data center includes the mappings and associations of each object logically contained in the data center in Austin.

According to aspects disclosed herein, if a user requests an object stored in the cloud storage system, and accesses the data center in Austin, the cloud storage system determines if the requested object is in the data center in Austin. If the lookup table contains the object, or meta data indicating where the object is to be found, the lookup table delivers this information to the user requesting the object.

Alternatively, if the object is not found in the data center in Austin, each data center in the cloud storage system will duplicate meta data associated with each bucket. The meta data associated with each bucket helps the user retrieve a data center which may contain the requested for object.

Thus, each data center may have a different lookup table corresponding to the objects stored in the data center. If a plurality of data centers have the same storage parameters, the lookup tables would be the same for the plurality of data centers, even though the lookup tables are customized for a respective data center.

In addition to the modifications to the redundancy specification, e.g., in extended redundancy specification 300, several protocols may be modified. In addition to changing the protocols for use with a multi-geographical cloud storage implementation, the list of key-lookup servers is explicit. An empty set (i.e., a call that does not denote any key-lookup servers) may be treated as a call to all key-lookup servers. Thus, if a user creates a bucket, a CREATE protocol is modified to also store the expected location of an object's meta data information, and the expected locations are sent to all of the data centers or to a subset of data centers determined by a function of the bucket name.

Once a bucket is created, a PUT protocol also may be edited. The PUT protocol allows a user or owner of a bucket to insert an object or file into a bucket. A cloud storage system, in response to an insert object instruction, will retrieve a bucket by performing the appropriate authentication. Alternatively, the PUT protocol may use the extended redundancy specification 300 to derive a set of data centers in which the object is inserted into. As long as the added object falls within the limits set (based on data[n] and parity[n]), the object will be inserted in the data center. Regardless of using an extended redundancy specification with the PUT protocol, the location information about the object being inserted is also maintained at location associated with the bucket that the object is being inserted to.

If data is stored in a bucket associated with a user of a cloud storage service, the user may retrieve the bucket, which is performed by the cloud storage system via a GET protocol. Thus, according to aspects disclosed herein, a GET protocol also may be modified. The GET protocol first establishes the available key-lookup servers based on the information contained in the extended redundancy specification 300 and a particular determined key for retrieval. Once a subset of data centers to retrieve fragments from is established, various fragments are requested from the data centers. Once enough fragments are retrieved to fully obtain the object, the GET protocol is successful.

Similar to the GET protocol being modified, an ENUMERATE protocol is modified according to aspects disclosed herein. The ENUMERATE protocol skips the fragment retrieving portions, and allows a cloud storage system to indicate if a specific object is in the cloud storage system.

CONVERGENCE and SCRUBBING protocols are also modified according to aspects disclosed here in. The CONVERGENCE protocol may be run periodically to determine if an object is not stored at a maximum redundancy. When the CONVERGENCE protocol makes this determination, it then determines whether the individual fragments are valid locally. The CONVERGENCE protocol then polls various fragment servers and key-lookup servers to determine if the mirrored fragments are available. The list of missing fragments associated with each object may be stored in a convergence log.

According to the aspects disclosed herein, a CONVERGENCE protocol is modified by either getting an expected list of key-lookup servers from the bucket (more efficient and less flexible implementation), or getting a list of key-lookup servers from the object associated with the fragment (less efficient and more flexible implementation). Either implementation may be used based on the efficiency and flexibility desired by a user.

The SCRUBBING protocol incrementally scans over the data stored in the system, and identifies fragments that have gone missing, key-lookup servers that have lost location information, or like the CONVERGENCE protocol, noting if an object is not at maximum redundancy. For similar reasons as noted with the CONVERGENCE protocol, the scrubbing protocol may also be modified according to aspects disclosed herein.

In certain cases, there may be multiple key-lookup servers associated with each data center. In this situation, a load balancing may be implemented by setting the maximum number of key-lookup servers associated with a bucket per data center. Thus, by implementing the load balancing, overfilling of a key-lookup server may be prevented. Further, a dynamic load balancing may be implemented as well to allow a sharing and even distribution of buckets.

Further, along with a cloud storage system according to this disclosure, the proxy server nodes 201 may be further modified based on desired performance versus flexibility. For example, if a user accesses data center associated with cloud storage system 100 for a certain object or fragment, the user may be presented with at least two different options. First, the data center may determine that the object is not located in any fragment server nodes 203 in the data center. Thus, the key-lookup servers node 202 may determine where the object is, and retrieve the object. Alternatively, the key-lookup servers node 202 could retrieve meta data indicating where the object is, and produce the meta data to the user. Thus, in both ways, information about a non-local bucket may be provided to the user.

1. A multi-geography cloud storage system, comprising:
a first data center, comprising:
a first non-transitory computer-readable storage medium having encoded thereon instructions for multi-geography cloud storage;
a first processor that executes the instructions to cause:
a first key-lookup server to access a first lookup table;
a first fragment server to store data or meta data associated with keys; and
a first plurality of buckets to logically contain the stored data or the meta data of the first fragment server; and
a second data center, comprising:
a second non-transitory computer-readable storage medium having encoded thereon the instruction for multi-geography cloud storage;
a second processor that executes the instructions to cause:
a second key-lookup server to access a second lookup table;
a second fragment server to store data or meta data associated with keys; and
a second plurality of buckets to logically contain the stored data or the meta data of the second fragment server,
wherein the first lookup table and the second lookup table are different from each other, and
each lookup table stores a mapping between the keys with the data or meta data stored in the corresponding fragment server.

2. The system according to claim 1, wherein the first lookup table and the second lookup table define a data limit and a parity limit for each data center.

3. The system according to claim 1, wherein:
the first data center comprises a first communication unit; and
the second data center comprises a second communication unit,
wherein the first communication unit and the second communication unit communicate with each other over a cloud network.

4. The system according to claim 1, further comprising:
a proxy server to determine which data centers have a lookup table for an object by using a redundancy specification associated with a bucket, in response to the first data center receiving a request to retrieve data, the first key-lookup server determines a location of the data from the first lookup table and the redundancy specification of the bucket.

5. The system according to claim 4, wherein if the first data center receives a request to enumerate data, the first key-lookup server determines a location of the data from the lookup table and the redundancy specification of the bucket.

6. The system according to claim 2, further comprising:
storing an object in the first data center or the second data center; and
creating an entry for a key associated with the object based on a user-defined selection.

7. The system according to claim 6, wherein the user-defined selection is a data limit.

8. The system according to claim 6, wherein the user-defined selection is a list of data centers.

9. The system according to claim 6, wherein the user-defined selection is a number of data centers to store the data.

10. The system according to claim 1, further comprising a redundancy specification associated with each key stored in the first fragment server or the second fragment server.

11. The system according to claim 10, wherein an object associated with a key in the second data center is stored based on an object associated with a key stored in the first data center via an erasure code.

12. A data center system, comprising:
a non-transitory computer-readable storage medium having encoded thereon instructions for multi-geography cloud storage; and
a processor that executes the instructions to cause:
a first key-lookup server to access a first lookup table;
a first fragment server to store data or meta data associated with keys; and
a plurality of buckets to logically contain the stored data or the meta data,
wherein the first lookup table is different from a second lookup table of at least one second data center that communicates with the data center system via a cloud network, and
the first lookup table stores a mapping between the keys with the data or meta data stored in the first fragment server.

13. The system according to claim 12, further comprising a redundancy specification associated with each key stored in the first fragment server.

14. A data center system, comprising:
a first non-transitory computer-readable storage medium having encoded thereon a instructions for multi-geography cloud storage; and
a first processor that executes the instructions to cause:
a proxy server to retrieve data from another data center;
a first key-lookup server to access a first lookup table;
a first fragment server to store data or meta data associated with keys; and
a plurality of buckets to logically contain the stored data or the meta data,
wherein the first lookup table is different from a lookup table of at least one other data center that communicates with the data center system via a cloud network,
the first lookup table stores a mapping between the keys with the data or meta data stored in the first fragment server, and
if a request for data indicates, via the first lookup table or information associated with the bucket, that the data is stored on a second data center, the proxy server retrieves the data from the second data center.

15. The system according to claim 14, further comprising a redundancy specification associated with each key stored in the first fragment server.
